(19) United States
(12) Patent Application Publication
(10) Pub. No.: US 2008/0151796 A1
(43) Pub. Date: Jun. 26, 2008

(54) Apparatus, method, and computer program product providing improved network service information delivery

(75) Inventor: Jari Jokela, Ylojarvi (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 12/004,800

(22) Filed: Dec. 21, 2007

Related U.S. Application Data
(60) Provisional application No. 60/876,949, filed on Dec. 22, 2006.

(51) Int. Cl. H04B 7/00

(52) U.S. Cl. 370/310

(57) ABSTRACT

The exemplary embodiments of the invention allow for a limited amount of network service information to be provided to stations without requiring a message exchange sequence. In one non-limiting, exemplary embodiment, a method includes: storing network service information for a wireless local area network; and transmitting a message comprising the network service information without first receiving a request for the network service information. As non-limiting examples, the message may be a beacon, a probe response or a generic advertisement service response. As a non-limiting example, the method may be implemented by an access point of the wireless local area network.

### CROSS-REFERENCE TO RELATED APPLICATIONS

This patent application claims priority under 35 U.S.C. §119(e) from Provisional Patent Application No. 60/876,949, filed Dec. 22, 2006, the disclosure of which is incorporated by reference herein in its entirety.

### TECHNICAL FIELD

The exemplary embodiments of this invention relate generally to wireless communication systems and, more specifically, relate to network service information delivery.

### BACKGROUND

The following abbreviations are employed:

ANSI American national standards institute
AP access point
DTIM delivery traffic identification message
GAS generic advertisement service
GASTIM generic advertisement service traffic indication message
IBSS independent basic service set
IEEE institute of electrical and electronics engineers
MAC medium access control layer
PHY physical layer
STA station
WLAN wireless local area network

IEEE P802.11u™/D0.02 (referred to herein as “802.11u”) is a draft amendment to the 802.11 standard and is currently under consideration. IEEE P802.11u™/D0.02, “Draft Amendment to Standard for Information Technology—Telecommunications and Information Exchange Between Systems—LAN/MAN Specific Requirements—Part 11: Wireless Medium Access Control (MAC) and physical layer (PHY) specifications: IEEE 802.11, Interworking with External Networks,” November 2006. 802.11u specifies enhancements to the 802.11 MAC that support WLAN Interworking with External Networks and allows higher layer functionalities to provide the overall end-to-end solution. 802.11u, Abstract. The disclosure of the IEEE P802.11u™/D0.02 draft amendment is incorporated by reference herein in its entirety. Furthermore, reference may be made to the ANSI/IEEE Std 802.11, 1999 Edition (R2003), Part 11: Wireless LAN Medium Access Control (MAC) and Physical Layer (PHY) Specifications (802.11), reaffirmed Jun. 12, 2003, also incorporated by reference herein in its entirety.

Under 802.11u, a STA requests information from the AP/network in order to obtain network service information. This is accomplished using the GAS procedures identified in the draft amendment. 802.11u specifies two mechanisms to obtain the information, one for unicast (Section 11.10.1.4) and one for multicast (Section 11.10.1.3). In both mechanisms, the STA initiates service discovery by sending a GAS Initial Request frame. The STA sends the GAS Initial Request frame because the service information is not included in the beacon or probe response(s). Thus, the STA needs to complete a message exchange sequence to obtain the service information. Note that in beacon and probe responses, an AP can inform a STA as to whether or not the AP supports GAS.

### SUMMARY

In an exemplary embodiment of the invention, a method includes: storing network service information for a wireless local area network; and transmitting a message comprising the network service information without first receiving a request for the network service information.

In another exemplary embodiment of the invention, a program storage device readable by a machine, tangibly embodying a program of instructions executable by the machine for performing operations, said operations including: storing network service information for a wireless local area network; and transmitting a message comprising the network service information without first receiving a request for the network service information.

In a further exemplary embodiment of the invention, an apparatus including: a memory configured to store network service information for a wireless local area network; and a transmitter configured to transmit a message comprising the network service information without first receiving a request for the network service information.

In another exemplary embodiment of the invention, an apparatus including: means for storing network service information for a wireless local area network; and means for transmitting a message comprising the network service information without first receiving a request for the network service information.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows an Advertising Protocol Information element in accordance with Section 7.3.2.38 of 802.11u;

FIG. 2 illustrates the format of the Delivery Method field of the Advertising Protocol Information element shown in FIG. 1, in accordance with Section 7.3.2.38 of 802.11u;

FIG. 3 depicts an exemplary Delivery Method field for an Advertising Protocol Information element incorporating aspects of the exemplary embodiments of the invention;

FIG. 4 depicts another exemplary Delivery Method field for an Advertising Protocol Information element incorporating aspects of the exemplary embodiments of the invention;

FIG. 5 shows a simplified block diagram of various electronic devices that are suitable for use in practicing the exemplary embodiments of this invention;

FIG. 6 depicts a flowchart illustrating one non-limiting example of a method for practicing the exemplary embodiments of this invention; and

FIG. 7 depicts a flowchart illustrating another non-limiting example of a method for practicing the exemplary embodiments of this invention.

### DETAILED DESCRIPTION

One reason the service information is not included in the beacon or probe response(s) is that in some cases there may be a large amount of service information, leading to beacon/probe response frames that are too long. However, requiring that the STA complete a message exchange sequence in order to obtain the service information may be undesirable, for example, if the amount of network service information is relatively small. Furthermore, in an IBSS network, where the number of available services is typically limited, it would be beneficial to avoid such a message exchange sequence.

The exemplary embodiments of the invention allow for a limited amount of network service level information to be provided to stations without requiring a message exchange sequence (e.g., carried in beacon and probe responses). In such a manner, in at least some cases, a message exchange sequence can be avoided. The exemplary embodiments of the invention enable simple network service information delivery. In conjunction with exemplary embodiments of the invention, a station may be able to use normal scanning procedures, for example, as there is no need for an additional GAS protocol exchange. Furthermore, network resources otherwise used for a message exchange sequence may be available for other uses. In some exemplary embodiments, the AP controls the amount of system overhead and uses the unsolicited deliver mode described below only if the amount of information is small and/or the load on the network is relatively light.

While the exemplary embodiments are described below in the context of a WLAN system, and further in the context of a WLAN system utilizing 802.11u, it should be appreciated that the exemplary embodiments of this invention are not limited for use with only this one particular type of wireless communication system, and that they may be used to advantage in other wireless communication systems.

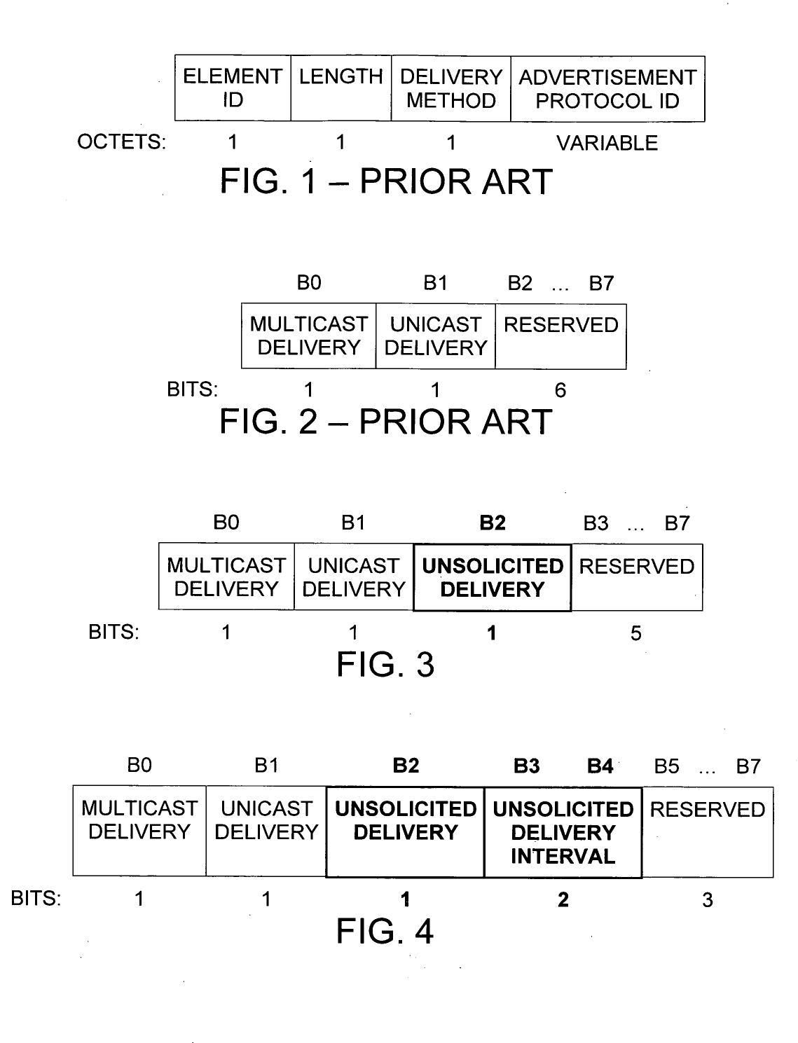

FIG. 1 shows an Advertising Protocol Information element in accordance with Section 7.3.2.38 of 802.11u. As explained in that section, “[t]he Advertising Protocol Information element contains information which identifies a particular advertisement protocol and its delivery method(s).” As shown in FIG. 1, the Advertising Protocol Information element includes four fields: an Element ID field (1 octet), a Length field (1 octet), a Delivery Method field (1 octet) and an Advertisement Protocol ID field (variable number of octets).

FIG. 2 illustrates the format of the Delivery Method field of the Advertising Protocol Information element shown in FIG. 1, in accordance with Section 7.3.2.38 of 802.11u. As stated in that section, “[t]he Delivery Method field is a 1-octet field which specifies multicast or unicast delivery method.”

In a first exemplary aspect of the invention, at least one bit of the Delivery Method field is allocated to convey whether at least some network service information is available in beacon and probe responses (e.g., whether the AP is sending GAS responses automatically in beacon and probe responses).

FIG. 3 illustrates an exemplary Delivery Method field for an Advertising Protocol Information element incorporating aspects of the exemplary embodiments of the invention. As shown in FIG. 3, an additional section has been allocated in the Delivery Method field: Unsolicited Delivery (1 bit). As a non-limiting example, if the Unsolicited Delivery bit is set to 1 for a particular advertisement protocol, the Delivery Method field indicates that the AP sends GAS responses automatically in beacon and probe responses.

Although shown in FIG. 3 using one section, any suitable number of sections may be used such that the Delivery Method field is configured to transmit information comprising the availability of GAS responses (e.g., automatic or non-automatic). Furthermore, any suitable number of bits may be allocated for the sections. The bits may be allocated such that the two bits specifying Multicast Delivery and Unicast Delivery remain in the Delivery Method field. In addition, the order of the bit allocations may be different from that shown in FIG. 3.

In a second exemplary aspect of the invention, in addition to the Unsolicited Delivery bit, at least one bit of the Delivery Method field is allocated to convey additional information specifying how often an AP sends GAS responses if the AP does not send GAS responses in every beacon. Note that if the AP sends GAS responses in every beacon, the additional allocation is unnecessary.

FIG. 4 depicts another exemplary Delivery Method field for an Advertising Protocol Information element incorporating aspects of the exemplary embodiments of the invention. As shown in FIG. 4, two additional sections have been allocated in the Delivery Method field: Unsolicited Delivery (1 bit) and Unsolicited Delivery Interval (2 bits). As a non-limiting example, the Unsolicited Delivery (1 bit) indicates whether Unsolicited Delivery is currently active (see FIG. 3). As a non-limiting example, the Unsolicited Delivery Interval (2 bits) is coded such that: “00” means every beacon; “01” means DTIM beacon; “10” means GASTIM beacon; and “11” is reserved. As a non-limiting example, if the Delivery Method is set to “Unsolicited Delivery,” the AP will include GAS responses in every Probe Response regardless of the contents of the Unsolicited Delivery Interval portion.

Although shown in FIG. 4 using two sections, any suitable number of sections may be used such that the Delivery Method field is configured to transmit information comprising a frequency with which the AP sends GAS responses. Furthermore, any suitable number of bits may be allocated for the sections. The bits may be allocated such that the two bits specifying Multicast Delivery and Unicast Delivery remain in the Delivery Method field. In addition, the order of the bit allocations may be different from that shown in FIG. 4.

As an additional non-limiting example, two additional sections may be allocated in the Delivery Method field: Unsolicited Delivery and Unsolicited Delivery Interval. The Unsolicited Delivery Interval section is coded such that it explicitly indicates the delivery interval. For example, the Unsolicited Delivery section may comprise 1 bit and the Unsolicited Delivery Interval section may comprise the remaining 5 bits and be used as an unsigned integer. For example, in the Unsolicited Delivery Interval section, “11111” would indicate that every 32nd beacon carries a GAS response.

TABLE 1

| Order | Information | Notes |
|---|---|---|
| 25 | Interworking Capability | Interworking Capability shall be |
| | | present if dot11InterworkingEnabled is |
| | | true. |
| 26 | Generic Advertisement | Advertisement Service Capability shall |
| | Service Capability | be present if |
| | | dot11AdvertisementServiceEnabled is |
| | | true. |
| 27 | Generic Advertisement | Present in Beacon if any of the |
| | Service Traffic Indication | supported Advertisement Protocols are |
| | Map | configured for multicast delivery. |
| 28 | ESSID | ESSID shall be present if |
| | | dot11InterworkingEnabled is present |
| 29 | Default Emergency | Optional (present if configured) |
| | Services Realm | |

Table 1 shows the Beacon frame body portions added by Section 7.2.4 of 802.11u.

TABLE 2

| Order | Information | Notes |
|---|---|---|
| 25 | Interworking Capability | Interworking Capability shall be |
| | | present if dot11InterworkingEnabled is |
| | | true. |
| 26 | Generic Advertisement | Advertisement Service Capability shall |
| | Service Capability | be present if |
| | | dot11AdvertisementServiceEnabled is |
| | | true. |
| 27 | Generic Advertisement | Present in Beacon if any of the |
| | Service Traffic Indication | supported Advertisement Protocols are |
| | Map | configured for multicast delivery. |
| 28 | ESSID | ESSID shall be present if |
| | | dot11InterworkingEnabled is present |
| 29 | Default Emergency | Optional (present if configured) |
| | Services Realm | |
| 30-n | GAS Response | Present if the delivery method of any |
| | Element(s) | of the supported Advertisement |
| | | Protocols is configured for |
| | | unsolicited delivery and Beacon is |
| | | either normal Beacon, DTIM Beacon |
| | | or GASTIM Beacon or present if the |
| | | delivery method of any of the |
| | | supported Advertisement Protocols |
| | | is configured for unsolicited delivery |
| | | and if the delivery interval indicates |
| | | this is a frame that contains a GAS |
| | | response. |

Table 2 shows exemplary changes that can be made to the Beacon frame body of Section 7.2.4 of 802.11u in order to support the exemplary embodiments of the invention.

TABLE 3

| Order | Information | Notes |
|---|---|---|
| 23 | Interworking Capability | Interworking Capability shall be |
| | | present if dot11InterworkingEnabled is |
| | | true. |
| 24 | Generic Advertisement | Advertisement Service Capability shall |
| | Service Capability | be present if |
| | | dot11AdvertisementServiceEnabled is |
| | | true. |
| 25 | ESSID | ESSID shall be present if |
| | | dot11InterworkingEnabled is present |

Table 3 shows the Probe Response frame body portions added by Section 7.2.4.8 of 802.11u.

TABLE 4

| Order | Information | Notes |
|---|---|---|
| 23 | Interworking Capability | Interworking Capability shall be |
| | | present if dot11InterworkingEnabled is |
| | | true. |
| 24 | Generic Advertisement | Advertisement Service Capability shall |
| | Service Capability | be present if |
| | | dot11AdvertisementServiceEnabled is |
| | | true. |
| 25 | ESSID | ESSID shall be present if |
| | | dot11InterworkingEnabled is present |
| 26-n | GAS Response | Present if the delivery method of any |
| | Element(s) | of the supported Advertisement |
| | | Protocols is configured for |
| | | unsolicited delivery. |

Table 4 shows exemplary changes that can be made to the Probe Response frame body of Section 7.2.4.8 of 802.11u in order to support the exemplary embodiments of the invention.

Note that in accordance with aspects of the exemplary embodiments of the invention, a station may also (i.e., still) use normal GAS procedures to obtain the network service information.

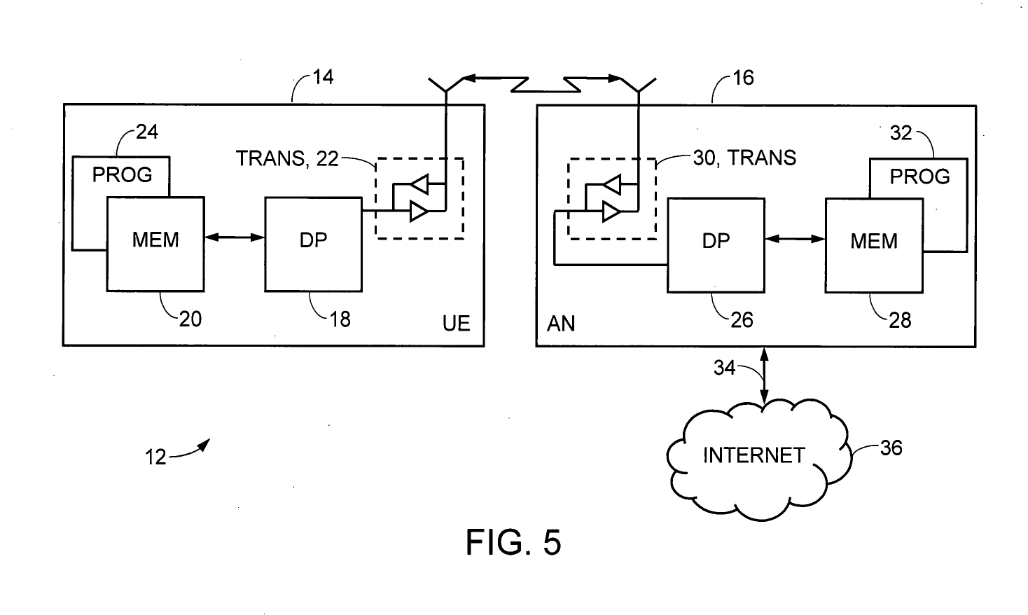

Reference is made to FIG. 5 for illustrating a simplified block diagram of various exemplary electronic devices that are suitable for use in practicing the exemplary embodiments of this invention. In FIG. 5, a wireless network 12 is adapted for communication with a user equipment (UE) 14 via an access node (AN) 16. The UE 14 includes a data processor (DP) 18, a memory (MEM) 20 coupled to the DP 18, and a suitable RF transceiver (TRANS) 22 (having a transmitter (TX) and a receiver (RX)) coupled to the DP 18. The MEM 20 stores a program (PROG) 24. The TRANS 22 is for bidirectional wireless communications with the AN 16. Note that the TRANS 22 has at least one antenna to facilitate communication.

The AN 16 includes a data processor (DP) 26, a memory (MEM) 28 coupled to the DP 26, and a suitable RF transceiver (TRANS) 30 (having a transmitter (TX) and a receiver (RX)) coupled to the DP 26. The MEM 28 stores a program (PROG) 32. The TRANS 30 is for bidirectional wireless communications with the UE 14. Note that the TRANS 30 has at least one antenna to facilitate communication. The AN 16 is coupled via a data path 34 to one or more external networks or systems, such as the internet 36, for example.

At least one of the PROGs 24, 32 is assumed to include program instructions that, when executed by the associated DP, enable the electronic device to operate in accordance with the exemplary embodiments of this invention, as discussed herein.

In general, the various embodiments of the UE 14 can include, but are not limited to, mobile nodes, mobile terminals, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 18, 26 of the UE 14 and the AN 16, or by hardware, or by a combination of software and hardware.

The MEMs 20, 28 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 18, 26 may be of any type suitable to the local technical environment, and may include one or more of general purpose computers, special purpose computers, microprocessors, digital signal processors (DSPs) and processors based on a multi-core processor architecture, as non-limiting examples.

In one non-limiting, exemplary embodiment, the wireless network 12 is a WLAN. In a further exemplary embodiment, the memory is configured to store network service information for the network 12 (e.g., a WLAN). In a further exemplary embodiment, the AN 16 is configured to transmit a message comprising the network service information via the TRANS 30 without first receiving a request for the network service information.

As can be seen, the exemplary embodiments of the invention allow for a limited amount of network service level information to be provided to stations without requiring a message exchange sequence (e.g., carried in beacon and probe responses).

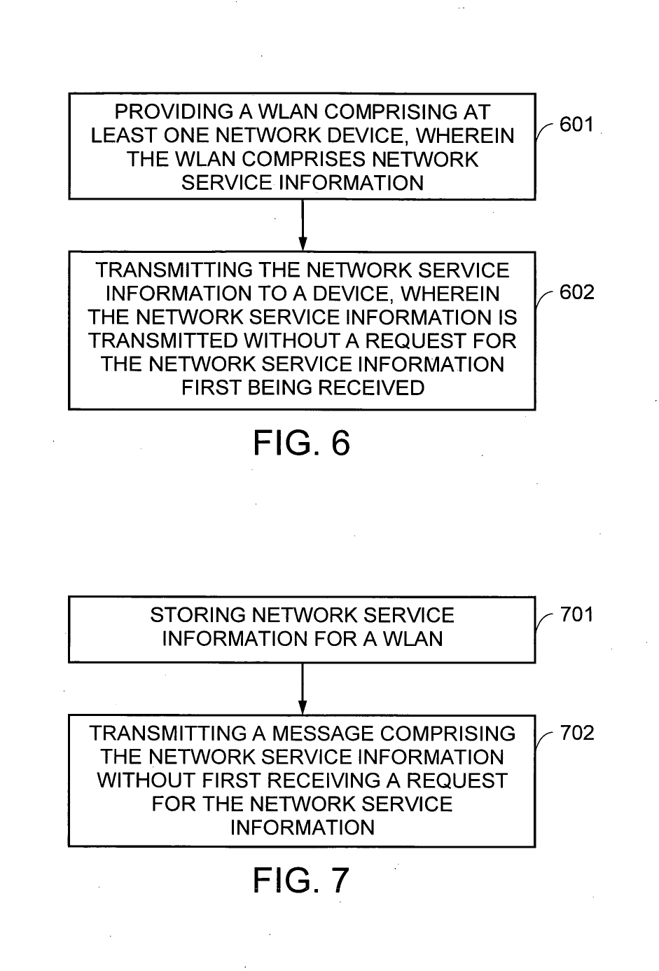

In one non-limiting, exemplary embodiment, and as illustrated in FIG. 6, a method includes: providing a WLAN comprising at least one network device, wherein the WLAN comprises network service information (box 601); and transmitting the network service information to a device, wherein the network service information is transmitted without a request for the network service information first being received (box 602). The network service information may be transmitted using a beacon or a probe response, as non-limiting examples. The transmitted network service information may comprise a GAS response. The GAS response may comprise an Advertising Protocol Information element. A Delivery Method field of the Advertising Protocol Information element may be modified to indicate whether the at least one network device sends GAS responses automatically in beacon and probe responses and/or to indicate, if the at least one network device does not send GAS responses automatically in beacon and probe responses, how often the at least one network device sends GAS responses. The at least one network device may comprise an AP. A Beacon frame body may be modified to include at least one entry for GAS Response Element(s). A Probe Response frame body may be modified to include at least one entry for GAS Response Element(s). The WLAN may comprise a IBSS network.

In another non-limiting, exemplary embodiment, a computer program product comprises program instructions embodied on a tangible computer-readable medium. Execution of the program instructions results in operations comprising: providing a WLAN comprising at least one network device, wherein the WLAN comprises network service information; and providing the network service information to a device, wherein the network service information is provided without a request for the network service information first being received.

In another non-limiting, exemplary embodiment, an apparatus comprises: a data processor and a transceiver coupled to the data processor. The data processor is configured to transmit network service information without first receiving a request for the network service information. The transmission may comprise a beacon or a probe response, as non-limiting examples.

In another non-limiting, exemplary embodiment, and as shown in FIG. 7, a method comprising: storing network service information for a WLAN (701); and transmitting a message comprising the network service information without first receiving a request for the network service information (702). The message may comprise a beacon or a probe response, as non-limiting examples.

In another non-limiting, exemplary embodiment, a program storage device readable by a machine, tangibly embodying a program of instructions executable by the machine for performing operations, said operations comprising: storing network service information for a WLAN; and transmitting a message comprising the network service information without first receiving a request for the network service information. The message may comprise a beacon or a probe response, as non-limiting examples.

In another non-limiting, exemplary embodiment, an apparatus comprises: a memory configured to store network service information and a transmitter configured to transmit a message comprising the network service information without first receiving a request for the network service information. The transmission may comprise a beacon or a probe response, as non-limiting examples.

In another non-limiting, exemplary embodiment, an apparatus comprises: a processor configured to obtain network service information and a transmitter configured to transmit a message comprising the network service information without first receiving a request for the network service information. The transmission may comprise a beacon or a probe response, as non-limiting examples.

In another non-limiting, exemplary embodiment, an apparatus comprises: means for storing network service information and means for transmitting a message comprising the network service information without first receiving a request for the network service information. The transmission may comprise a beacon or a probe response, as non-limiting examples. The means for storing may comprise a memory and the means for transmitting may comprise a transmitter.

In a further non-limiting, exemplary embodiment, an apparatus comprises: means for obtaining network service information and means for transmitting a message comprising the network service information without first receiving a request for the network service information. The transmission may comprise a beacon or a probe response, as non-limiting examples. The means for obtaining may comprise a data processor and the means for transmitting may comprise a transmitter.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The exemplary embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the non-limiting and exemplary embodiments of this invention.

Furthermore, some of the features of the preferred embodiments of this invention could be used to advantage without the corresponding use of other features. As such, the foregoing description should be considered as merely illustrative of the principles, teachings and exemplary embodiments of this invention, and not in limitation thereof.

What is claimed is:

1. A method comprising:
storing network service information for a wireless local area network; and
transmitting a message comprising the network service information without first receiving a request for the network service information.

2. A method as in claim 1, wherein the message comprises a beacon or a probe response.

3. A method as in claim 1, wherein the message comprises a generic advertisement service response.

4. A method as in claim 1, wherein the message comprises a generic advertisement service response comprising an advertising protocol information element, wherein a field of the advertising protocol information element is indicative of whether or not generic advertisement service responses are sent automatically in beacon and probe responses.

5. A method as in claim 1, wherein the message comprises a generic advertisement service response comprising an advertising protocol information element, wherein a first field of the advertising protocol information element is indicative that generic advertisement service responses are not sent automatically in beacon and probe responses, wherein a second field of the advertising protocol information element is indicative of a frequency with which generic advertisement service responses are sent.

6. A method as in claim 5, wherein the first field comprises the second field.

7. A method as in claim 1, wherein the method is implemented by an access point of the wireless local area network.

8. A program storage device readable by a machine, tangibly embodying a program of instructions executable by the machine for performing operations, said operations comprising:
storing network service information for a wireless local area network; and
transmitting a message comprising the network service information without first receiving a request for the network service information.

9. A program storage device as in claim 8, wherein the message comprises a beacon or a probe response.

10. A program storage device as in claim 8, wherein the message comprises a generic advertisement service response.

11. A program storage device as in claim 8, wherein the message comprises a generic advertisement service response comprising an advertising protocol information element, wherein a field of the advertising protocol information element is indicative of whether or not generic advertisement service responses are sent automatically in beacon and probe responses.

12. A program storage device as in claim 8, wherein the message comprises a generic advertisement service response comprising an advertising protocol information element, wherein a first field of the advertising protocol information element is indicative that generic advertisement service responses are not sent automatically in beacon and probe responses, wherein a second field of the advertising protocol information element is indicative of a frequency with which generic advertisement service responses are sent.

13. A program storage device as in claim 12, wherein the first field comprises the second field.

14. A program storage device as in claim 8, wherein the machine comprises an access point of the wireless local area network.

15. An apparatus comprising:
a memory configured to store network service information for a wireless local area network; and
a transmitter configured to transmit a message comprising the network service information without first receiving a request for the network service information.

16. An apparatus as in claim 15, wherein the message comprises a beacon or a probe response.

17. An apparatus as in claim 15, wherein the message comprises a generic advertisement service response.

18. An apparatus as in claim 15, wherein the message comprises a generic advertisement service response comprising an advertising protocol information element, wherein a field of the advertising protocol information element is indicative of whether or not generic advertisement service responses are sent automatically in beacon and probe responses.

19. An apparatus as in claim 15, wherein the message comprises a generic advertisement service response comprising an advertising protocol information element, wherein a first field of the advertising protocol information element is indicative that generic advertisement service responses are not sent automatically in beacon and probe responses, wherein a second field of the advertising protocol information element is indicative of a frequency with which generic advertisement service responses are sent.

20. An apparatus as in claim 19, wherein the first field comprises the second field.

21. An apparatus as in claim 15, wherein the apparatus comprises an access point of the wireless local area network.

22. An apparatus comprising:
means for storing network service information for a wireless local area network; and
means for transmitting a message comprising the network service information without first receiving a request for the network service information.

23. An apparatus as in claim 22, wherein the means for storing comprises a memory and the means for transmitting comprises a transmitter.

24. An apparatus as in claim 22, wherein the message comprises a beacon, a probe response.

25. An apparatus as in claim 22, wherein the apparatus comprises an access point of the wireless local area network.
